(19) United States
(12) Patent Application Publication
(10) Pub. No.: US 2026/0179399 A1
(43) Pub. Date: Jun. 25, 2026

(54) Visibility Based Annotation Generation

(71) Applicant: Google LLC, Mountain View, CA (US)

(72) Inventors: Robert Raymond Pasquini, Sunnyvale, CA (US); Carlos David Correa Ocampo, Santa Carla, CA (US)

(21) Appl. No.: 18/988,118

(22) Filed: Dec. 19, 2024

(51) Int. Cl. G06V 20/70; G06T 17/05; G06T 19/00; G06V 10/26

(52) U.S. Cl. CPC G06V 20/70; G06T 17/05; G06T 19/006; G06V 10/26; G06T 2219/004

(57) ABSTRACT

Methods, systems, devices, and non-transitory computer readable media for determining landmark visibility and generating annotations are provided. The disclosed technology can include receiving map data comprising three-dimensional models of structures in a physical environment. Portions of the three-dimensional models of structures that are visible from map projection cells associated with the physical environment can be determined. Visibility data associated with portions of the three-dimensional models that are visible from each of the map projection cells and comprising visibility cells corresponding to the map projection cells can be generated. View data associated with a visual representation of the physical environment from a location can be received. Based on the visibility data and view data, the visibility cell associated with the location in the physical environment can be determined. Based on point of interest data, points of interest associated with the visibility cells can be determined and annotations can be generated.

### FIELD

The present disclosure relates generally to generating annotations based on the determination of the visibility of structures in a physical environment. More particularly the present disclosure relates to generating annotations for points of interest based on processing three-dimensional models of structures in a physical environment that are visible from various viewpoint locations.

### BACKGROUND

Maps can be used to represent various features of a geographic region. In some instances, the maps can include marked images that may indicate different locations in a geographic region. The marked images can be used in a variety of applications including mapping applications that can use tags and other labels to identify interesting objects within a geographic region. However, manually labelling maps can be labor intensive. Furthermore, especially when performed on large maps, manually labelling interesting objects can be time consuming. However, there may be significant benefits to labelling maps such that interesting objects in a geographic region are indicated. Accordingly, there may be different approaches to providing visual representations of geographic regions.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of determining the visibility of structures in an environment. The computer-implemented method can comprise receiving, by a computing system comprising one or more processors, map data comprising a plurality of three-dimensional models of structures in a physical environment. The computer-implemented method can comprise determining, by the computing system, one or more portions of the plurality of three-dimensional models of structures that are visible from each map projection cell of a plurality of map projection cells that correspond to a plurality of locations in the physical environment. The computer-implemented method can comprise generating, by the computing system, visibility data comprising a plurality of visibility cells associated with the plurality of map projection cells and the one or more portions of the plurality of three-dimensional models of structures that are visible from each map projection cell of the plurality of map projection cells. The computer-implemented method can comprise receiving, by the computing system, view data comprising information associated with a visual representation of the physical environment from a location of the plurality of locations in the physical environment. The computer-implemented method can comprise determining, by the computing system, based on the view data and the visibility data, one or more visibility cells of the plurality of visibility cells that are associated with the map projection cell that corresponds to the location in the physical environment. The computer-implemented method can comprise determining, by the computing system, based on point of interest data, one or more points of interest associated with the one or more visibility cells. The computer-implemented method can comprise generating, by the computing system, one or more annotations based on the one or more points of interest that are visible from the map projection cell associated with the location.

Another example aspect of the present disclosure is directed to one or more tangible non-transitory computer-readable media storing computer-readable instructions that when executed by one or more processors cause the one or more processors to perform operations. The operations can comprise receiving map data comprising a plurality of three-dimensional models of structures in a physical environment. The operations can comprise determining one or more portions of the plurality of three-dimensional models of structures that are visible from each map projection cell of a plurality of map projection cells that correspond to a plurality of locations in the physical environment. The operations can comprise generating visibility data comprising a plurality of visibility cells associated with the plurality of map projection cells and the one or more portions of the plurality of three-dimensional models of structures that are visible from each map projection cell of the plurality of map projection cells. The operations can comprise receiving view data comprising information associated with a visual representation of the physical environment from a location of the plurality of locations in the physical environment. The operations can comprise determining, based on the view data and the visibility data, one or more visibility cells of the plurality of visibility cells that are associated with the map projection cell that corresponds to the location in the physical environment. The operations can comprise determining, based on point of interest data, one or more points of interest associated with the one or more visibility cells. The operations can comprise generating one or more annotations based on the one or more points of interest that are visible from the map projection cell associated with the location.

Another example aspect of the present disclosure is directed to a computing system comprising: one or more processors; one or more non-transitory computer-readable media storing instructions that when executed by the one or more processors cause the one or more processors to perform operations. The operations can comprise receiving map data comprising a plurality of three-dimensional models of structures in a physical environment. The operations can comprise determining one or more portions of the plurality of three-dimensional models of structures that are visible from each map projection cell of a plurality of map projection cells that correspond to a plurality of locations in the physical environment. The operations can comprise generating visibility data comprising a plurality of visibility cells associated with the plurality of map projection cells and the one or more portions of the plurality of three-dimensional models of structures that are visible from each map projection cell of the plurality of map projection cells. The operations can comprise receiving view data comprising information associated with a visual representation of the physical environment from a location of the plurality of locations in the physical environment. The operations can comprise determining, based on the view data and the visibility data, one or more visibility cells of the plurality of visibility cells that are associated with the map projection cell that corresponds to the location in the physical environment. The operations can comprise determining, based on point of interest data, one or more points of interest associated with the one or more visibility cells. The operations can comprise generating one or more annotations based on the one or more points of interest that are visible from the map projection cell associated with the location.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that can determine the visibility of structures in an environment according to example embodiments of the present disclosure;

FIG. 1B depicts a block diagram of an example computing device that can determine the visibility of structures in an environment according to example embodiments of the present disclosure;

FIG. 1C depicts a block diagram of an example computing device that can determine the visibility of structures in an environment according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts a diagram of a computing system configured to determine the visibility of structures in an environment according to example embodiments of the present disclosure;

FIG. 5 depicts an example of an interface for displaying annotations of visible structures in an environment according to example embodiments of the present disclosure;

FIG. 6 depicts an example of an interface for displaying annotations of visible structures in an environment according to example embodiments of the present disclosure;

FIG. 7 depicts an example of an interface for displaying annotations of visible structures in an environment according to example embodiments of the present disclosure;

FIG. 8 depicts a flow chart diagram of an example method of determining the visibility of structures in an environment according to example embodiments of the present disclosure;

FIG. 9 depicts a flow chart diagram of an example method of determining the visibility of structures in an environment according to example embodiments of the present disclosure;

FIG. 10 depicts a flow chart diagram of an example method of determining the visibility of structures in an environment according to example embodiments of the present disclosure;

FIG. 11 depicts a flow chart diagram of an example method of determining the visibility of structures in an environment according to example embodiments of the present disclosure; and

FIG. 12 depicts a flow chart diagram of an example method of determining the visibility of structures in an environment according to example embodiments of the present disclosure.

Reference numerals that are repeated across plural figures are intended to identify the same features in various implementations.

### DETAILED DESCRIPTION

In general, the present disclosure is directed to determining the visibility of structures and generating annotations associated with the structures. In particular, visibility data generated based on map data that includes three-dimensional models of structures in an environment can be used to determine the visibility of structures in a physical environment and generate annotations. Further, the annotations can be generated in a variety of implementations including a live video-stream of a physical environment such that annotations associated with landmarks and other points of interest can be generated, thereby assisting in the performance of navigation related tasks. Additionally, the disclosed technology can implement machine-learned models that can be configured and/or trained to perform various operations including improving the determination of the placement of annotations and automatically filtering transient features that occlude visibility.

The disclosed technology can include a computing system that receives data comprising map data that can comprise a plurality of three-dimensional models of structures in a physical environment. For example, the map data can comprise a three-dimensional model of a city that comprises three-dimensional models of buildings and other structures in the city. Further, the computing system can determine one or more portions of the plurality of three-dimensional models of structures that are visible from each map projection cell of a plurality of map projection cells that correspond to a plurality of locations in the physical environment. For example, the computing system can perform one or more ray casting operations to determine the portions of the three-dimensional models of buildings and other structures that are visible from locations in the physical environment (e.g., locations on the ground surface of the physical environment).

Visibility data that comprises a plurality of visibility cells associated with the plurality of map projection cells can be generated. Further, each visibility cell of the plurality of visibility cells can be associated with the one or more portions of the plurality of three-dimensional models of structures that are visible from each map projection cell of the plurality of map projection cells. For example, the visibility data can comprise information associated with a map projection cell (e.g., an S2 cell) that corresponds to a region or area in the physical environment. Further, each map projection cell can be associated with a plurality of visibility cells that indicate portions of the plurality of three-dimensional structures that are visible from each map projection cell. For example, a map projection cell that corresponds to a location on a city street can be associated with a plurality of visibility cells that indicate the portions of the three-dimensional structures (e.g., buildings) that are visible from the map projection cell.

The computing system can then receive view data that can comprise information associated with a visual representation of the physical environment from a location of the plurality of locations in the physical environment. For example, the view data can comprise image data and/or video data from a smartphone associated with the computing system. The view data from the smartphone can comprise images and/or video of the physical environment that is within the field of view of a camera of the smartphone. In some embodiments, the view data can comprise location information including geographical coordinates corresponding to the current location of the device that captures the images and/or video on which the view data is based. The computing system can then determine, based on the view data and the visibility data, one or more visibility cells of the plurality of visibility cells that are associated with the map projection cell that corresponds to the location in the physical environment.

Based on point of interest data, the computing system can determine one or more points of interest associated with the visibility cell. For example, the computing system can access point of interest data that indicates the locations of points of interest in the physical environment. The computing system can then use the visibility cells associated with a current location to determine the portions of the three-dimensional models of structures that match locations of points of interest that are indicated in the point of interest data and visible from the current location.

The computing system can then generate one or more annotations based on the one or more points of interest that are visible from the map projection cell associated with the location. For example, based on the computing system determining that a point of interest (e.g., a historical building) is visible from the location associated with a map projection cell, one or more annotations can be generated above the point of interest. The size and color of the one or more annotations can be adjusted to facilitate visibility of the one or more annotations. Further, the color of the annotations can be adjusted to make the annotations more legible. For example, dark colored text can be used for an annotation that has a light background behind the annotation. By way of further example, light colored text can be used for an annotation that has a dark colored background behind it. The computing system can then generate modified view data that is based on the view data and the one or more annotations. For example, the computing system can generate modified view data that can comprise the one or more annotations superimposed over a video stream. The computing system can then use the modified view data to generate an augmented reality environment that can automatically display annotations to indicate the locations of points of interest.

Accordingly, the disclosed technology can automatically determine the visibility of structures and generate annotations for visual representations of physical environments. In particular, the disclosed technology can be used to automatically generate annotations based on the visibility of structures (e.g., points of interest including landmarks) in a physical environment. Further, the disclosed technology can assist a user in more effectively and/or safely performing the technical task of navigation by means of a continued and/or guided human-machine interaction process in which view data associated with images of a physical environment can be received and annotations are generated based on continuously updated view data. For example, view data comprising a visual representation of a physical environment can be processed on a continuous basis, thereby facilitating navigation.

The disclosed technology can be implemented in a computing system (e.g., a visibility determination computing system) that is configured to access data and/or perform operations on the data. For example, the operations performed by the computing system can comprise receiving map data comprising three-dimensional models of structures in a physical environment, determining portions of the three-dimensional models of structures that are visible from each map projection cell of a plurality of map projection cells that correspond to locations in the physical environment, generating visibility data comprising visibility cells associated with the map projection cells, receiving view data comprising information associated with a visual representation of the physical environment from a location in the physical environment, determining the map projection cell and visibility cell that are associated with the location in the physical environment, determining points of interest associated with the visibility cell, and/or generating annotations based on the points of interest that are visible from the map projection cell associated with the location. Further, the computing system can leverage one or more machine-learned models that have been configured and/or trained to process input comprising map data, view data, and/or point of interest data and generate annotations based on the input.

The computing system can be included as part of a system that includes a server computing device that receives data (e.g., map data) from a user’s client computing device, performs operations based on the data and sends output comprising annotation data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with receiving map data comprising three-dimensional models of structures in a physical environment, determining portions of the three-dimensional models of structures that are visible from each map projection cell of a plurality of map projection cells that correspond to locations in the physical environment, generating visibility data comprising visibility cells associated with the map projection cells, receiving view data comprising information associated with a visual representation of the physical environment that is visible from a location in the physical environment, determining the map projection cell and visibility cell that are associated with the location in the physical environment, determining points of interest associated with the visibility cell, and/or generating annotations based on the points of interest that are visible from the map projection cell associated with the location.

A computing system can receive, obtain, and/or retrieve map data. The map data can comprise a plurality of three-dimensional models of structures in a physical environment. The plurality of three-dimensional models of structures in a physical environment can comprise three-dimensional models that are associated with other three-dimensional models. For example, a three-dimensional model of a city can comprise three-dimensional models of various structures within the three-dimensional model of the city. Further, one or more portions of the plurality of three-dimensional models can be partly or wholly connected to other three-dimensional models (e.g., a three-dimensional model of a building that is partly connected to another three-dimensional model of a building), within other three-dimensional models, or separate from other three-dimensional models.

The structures (e.g., the structures on which the plurality of three-dimensional models are based) can comprise one or more buildings (e.g., office buildings, residential homes, apartment complexes, shopping centers, and/or schools), one or more statues, one or more fountains, one or more gates (e.g., the gates of a park or the gates indicating a particular neighborhood), one or more roads, one or more trees, one or more vehicles, one or more natural formations (e.g., rock formations, bodies of water, and/or forests), one or more waterways (e.g., canals), and/or one or more bridges.

The map data can be associated with one or more geographic locations. Further, the map data can comprise information associated with one or more locations of one or more objects including structures in a physical environment. The map data can include information associated with the latitude, longitude, and/or altitude of one or more objects including one or more structures in a physical environment.

The plurality of three-dimensional models of structures in the physical environment can correspond to actual structures in the physical environment. For example, the plurality of three-dimensional models of structures in the physical environment can be associated with coordinates (e.g., latitude, longitude, and/or altitude) that indicate the locations of structures in the physical environment. By way of further example, the map data can comprise a three-dimensional model of a structure comprising an office building that corresponds to an actual building in a physical environment. Further, the proportions of the plurality of three-dimensional models of structures in the physical environment can correspond to the proportions of the actual structures in the physical environment.

In some embodiments, the map data can comprise and/or be associated with location data, navigation data, and/or geographic data. Further, the map data can be configured for use by map applications, navigation applications, and/or mapping applications. For example, the map data can be used by a map application that can provide indications associated with the locations of points of interest that are around the current location of a user.

The computing system can determine one or more portions of the plurality of three-dimensional models (e.g., three-dimensional models of structures) that are visible. The computing system can determine a plurality of locations in the plurality of three-dimensional models comprising locations that correspond to locations in the physical environment that are accessible to a pedestrian including locations associated with a ground level of the physical environment and/or other elevated locations including parts of buildings (e.g., a viewing platform of a skyscraper and/or tower). In some embodiments, the computing system can determine that the lowest height of the plurality of three-dimensional models at a location within the plurality of three-dimensional models corresponds to a ground surface of the physical environment. The viewpoint from each location can be at a height that is a predetermined height (e.g., one meter or two meters) above the lowest height of the plurality of three-dimensional models at that location.

The computing system can then determine lines of sight from the locations to the surroundings comprising the plurality of three-dimensional models. For example, the computing system can determine the unobstructed lines of sight from each of the locations. Based on the lines of sight, the computing system can determine that the one or more portions of the plurality of three-dimensional models of structures that are visible from each map projection cell correspond to the surfaces of the plurality of three-dimensional models that have an unobstructed line of sight from each location.

Further, the computing system can determine one or more portions of the plurality of three-dimensional models that are visible from each map projection cell of a plurality of map projection cells. The computing system can determine the plurality of map projection cells that correspond to the physical environment. For example, the computing system can determine the geographical locations corresponding to the plurality of three-dimensional models and then determine the plurality of map projection cells that correspond to the geographical locations. The computing system can then determine the unobstructed (e.g., unobstructed by a surface of a three-dimensional model) visibility in every direction from each map projection cell of the plurality of map projection cells.

The plurality of map projection cells can correspond to a plurality of locations in the physical environment. The plurality of map projection cells can comprise a plurality of equally sized cells that are a two-dimensional representation of a portion of the surface of a three-dimensional object. The plurality of map projection cells can comprise a two-dimensional area associated with a map that corresponds to the three-dimensional surface of the Earth from which the map is based. Further, each map projection cell of the plurality of map projection cells can correspond to a set of geographic coordinates. For example, if a three-dimensional model of a building has a footprint that covers the physical environment equivalent of four-hundred square meters of the ground surface of the three-dimensional model, the plurality of map projection cells can correspond to the footprint of the three-dimensional model of the building. Further, the plurality of map projection cells can be subdivided into smaller map projection cells that can correspond to more granular portions of a surface. In some embodiments, the plurality of map projection cells can comprise a plurality of S2 cells.

Determining one or more portions of the plurality of three-dimensional models of structures that are visible from each map projection cell (e.g., map projection cell of a plurality of map projection cells that correspond to a plurality of locations in the physical environment) can comprise determining, based on performance of one or more surface visibility operations, the one or more portions of the plurality of three-dimensional models of structures that are visible from each map projection cell of a plurality of map projection cells that correspond to the plurality of locations in the physical environment. The one or more surface visibility operations can comprise one or more ray casting operations and/or one or more ray tracing operations.

Determining one or more portions of the plurality of three-dimensional models of structures that are visible from each map projection cell of a plurality of map projection cells that correspond to a plurality of locations in the physical environment can comprise determining that the one or more portions of the plurality of three-dimensional models of structures are within a predetermined distance of each map projection cell of the plurality of map projection cells. For example, the computing system can determine that the visibility of the one or more portions of the plurality of three-dimensional models of structures is limited to a thirty kilometer radius around each map projection cell of the plurality of map projection cells. The predetermined distance can be increased and/or decreased to allow for greater or lesser distances from each map projection cell.

The computing system can generate visibility data. The visibility data can comprise a plurality of visibility cells associated with the plurality of map projection cells and/or the one or more portions of the plurality of three-dimensional models of structures that are visible from each map projection cell of the plurality of map projection cells. Each visibility cell of the plurality of visibility cells of the visibility data can comprise one or more portions of the plurality of three-dimensional models that are visible from a particular map projection cell. Further, the one or more portions of the plurality of three-dimensional models of structures that are visible can comprise an area or region of the surface of the three-dimensional model that is visible from a map projection cell.

The computing system can receive view data. The view data can comprise information associated with a visual representation of the physical environment from a location of the plurality of locations in the physical environment. The view data can be received from a mobile computing device that is part of and/or associated with the computing system. The mobile device can comprise a camera, a smartphone, a tablet computing device, augmented reality glasses, an augmented reality headset, a virtual reality headset, and/or an extended reality (XR) headset. In some embodiments, the view data can comprise information associated with an image included in the view data and/or a device that captured the visual representation of the physical environment. For example, the view data can comprise a camera configuration, ISO, shutter speed, and/or frame rate associated with the device that captured an image of the physical environment.

The view data can comprise one or more images (e.g., one or more two-dimensional images) of the physical environment. For example, the view data can comprise an image of a street that is captured by a camera. In some embodiments, the view data can comprise location data that indicates a location (e.g., a map projection cell associated with a location and/or a latitude, longitude, and/or altitude associated with a location) from which an image was captured.

In some embodiments, the view data can comprise a three-dimensional representation of the physical environment. Further, surfaces of the three-dimensional representation of the physical environment can be based on images of corresponding surfaces of the physical environment. For example, the view data can comprise a three-dimensional model of the physical environment that is in a format that can be similar to the plurality of three-dimensional models of structures of the map data.

Further, the view data can comprise a video stream associated with the visual representation of the physical environment from a field of view of an image capture device at the location. For example, the video data can comprise a live video stream that captures a plurality of video images of a physical location via a smartphone camera or an augmented reality device’s camera (e.g., one or more cameras of augmented reality glasses).

The computing system can determine one or more visibility cells of the plurality of visibility cells that are associated with the map projection cell that corresponds to the location in the physical environment. The computing system can determine the one or more visibility cells that are associated with the map projection cell that corresponds to the location in the physical environment based on the view data and/or the visibility data.

Determining, based on the view data and/or the visibility data, one or more visibility cells of the plurality of visibility cells that are associated with the map projection cell that corresponds to the location in the physical environment can comprise and/or be based on inputting the view data (e.g., view data comprising one or more two-dimensional images of the physical environment and/or a three-dimensional representation of the physical environment) and/or the visibility data into one or more machine-learned models. The one or more machine-learned models can be configured and/or trained to determine the one or more visibility cells that are associated with the map projection cell that corresponds to the location in the physical environment based on detection, recognition, or classification of one or more features of view data (e.g., view data comprising one or more two-dimensional images of the physical environment and/or a three-dimensional representation of the physical environment). For example, the one or more machine-learned models can be configured and/or trained based on training data comprising a plurality of training images of the physical environment (e.g., images captured from different locations and/or points of view) and corresponding ground-truth location identifiers (e.g., a location identifier indicating the geographic location from which a training image was captured). By way of further example, the one or more machine-learned models can be configured and/or trained based on training data comprising a plurality of training three-dimensional models of the physical environment and corresponding ground-truth location identifiers (e.g., a location identifier indicating the geographic location associated with a three-dimensional model). The one or more machine-learned models can be configured and/or trained to determine the one or more visibility cells that are associated with a map projection cell based on detection, recognition, and/or classification of three-dimensional shapes that can correspond to the shape of structures at locations in the physical environment.

The computing system can generate point of interest data. The point of interest data can be associated with one or more points of interest that are salient and/or visually prominent. For example, the one or more points of interest associated with the point of interest data can comprise one or more historical buildings, one or more museums, one or more shopping centers, one or more museums, one or more art galleries, one or more stadia, one or more university buildings, one or more schools, one or more places of worship, one or more auditoriums, one or more cinemas, one or more hotels, one or more zoos, one or more amusement parks, one or more airports, one or more hospitals, and/or one or more parks.

Generating the point of interest data can be based on inputting a plurality of images of the physical environment into one or more machine-learned models. The one or more machine-learned models can be configured to generate the point of interest data based on detection, recognition, and/or classification of one or more features of the plurality of images that correspond to one or more points of interest. Further, the point of interest data can be generated based on the selection of one or more points of interest by one or more machine-learned models that are configured and/or trained to select points of interest based on one or more point of interest criteria comprising user ratings or rankings of locations (e.g., high user ratings of certain locations may indicate that a location is a point of interest), user reviews of locations (e.g., favorable or detailed user reviews of locations in online applications or websites can indicate that certain locations are points of interest), and/or historical data indicating historical points of interest (e.g., the Eiffel tower in Paris and/or the Hermitage in Saint Petersburg can be indicated to be historical points of interest in texts that can include historical texts and/or popular texts).

In some embodiments, the point of interest data can be based on points of interest that are indicated based on information received by one or more map applications, one or more navigation applications, and/or one or more mapping applications. For example, visitors to various points of interest can send information indicating that a location is a point of interest, images of a point of interest, video of the point of interest, and/or indications of the location (e.g., geographic location and/or address) of a point of interest.

The computing system can determine one or more points of interest. The one or more points of interest can be associated with the one or more visibility cells. Further, determining the one or more points of interest can be based on point of interest data. For example, the computing system can determine a location in the physical environment based on the map projection cell that is associated with the one or more visibility cells (e.g., the geographical location associated with the one or more portions of the three-dimensional model of a structure that is visible from a map projection cell). Further, the computing system can access point of interest data which comprises point of interest identifiers (e.g., the names of points of interest comprising historical locations) and corresponding point of interest locations (e.g., geographical locations of points of interest). The computing system can then compare the location of the one or more visibility cells to the point of interest locations to determine one or more points of interest that are associated with the one or more visibility cells.

A computing system can generate one or more annotations. The annotations can be generated based on the one or more points of interest that are visible from the map projection cell associated with the location. For example, the computing system can generate one or more annotations that can be rendered in a two-dimensional image, a video stream, a virtual reality environment, and/or an augmented reality environment. The one or more annotations can be generated in a location that is within a predetermined distance of the one or more points of interest. For example, the one or more annotations can be generated within a three-dimensional model of a structure associated with a point of interest that corresponds to a distance of ten meters from the point of interest in the physical environment.

Generating one or more annotations based on the one or more points of interest that are visible from the map projection cell associated with the location can comprise determining and/or modifying an appearance of the one or more annotations based on a distance of the one or more points of interest from the map projection cell. The appearance of the one or more annotations can comprise the size of the one or more annotations, a font of the one or more associated, and/or a color of the one or more annotations. For example, the computing system can increase or decrease the size of the one or more annotations so that multiple annotations are legible within a field of view of a viewing environment (e.g., a viewing environment displayed on a display component of the computing system). By way of further example, the computing system can change the color of the one or more annotations (e.g., make an annotation lighter, darker, red, green, yellow, white, or black) to improve the contrast of the one or more annotations relative to the background. Further, the computing system can change the font of the one or more annotations such that certain fonts are in bold to emphasize certain locations including historical landmarks.

Generating one or more annotations (e.g., generating one or more annotations based on the one or more points of interest that are visible from the map projection cell associated with the location) can comprise detecting and/or determining one or more transient objects that occlude the one or more points of interest. For example, the computing system can perform one or more object detection, recognition, and/or classification objects and recognize transient objects including vehicles, tree branches, and/or people that may occlude the visibility of points of interest. In some embodiments, the computing system can implement one or more machine-learned models that are configured and/or trained to detect, recognize, and/or classify one or more transient objects. The one or more transient objects can comprise one or more objects that are mobile (e.g., a vehicle), growing (e.g., a tree branch), or that is present in a location for a short period of time (e.g., a car or delivery truck that is parked at a location for 15 minutes). For example, the one or more transient objects can comprise one or more vehicles, foliage, one or more temporary signs, and/or one or more pedestrians.

Generating the one or more annotations can comprise determining that the one or more annotations are generated in a location that does not include the one or more transient objects. For example, if a tree branch occludes a point of interest, the computing system can determine that the one or more annotations can be generated in a location such that the one or more annotations are above or below the tree branch. By way of further example, if a transient object comprising a delivery truck occludes a point of interest, the computing system can determine that the one or more annotations can be generated in a location that does not include the delivery truck.

Generating one or more annotations based on the one or more points of interest that are visible from the map projection cell associated with the location can comprise determining, based on the visibility data, that the one or more annotations are within a predetermined distance of the one or more points of interest. For example, the one or more annotations can be generated within a three-dimensional model of a structure associated with a point of interest that corresponds to a distance of five meters from the point of interest in the physical environment.

Generating one or more annotations based on the one or more points of interest that are visible from the map projection cell associated with the location can comprise determining one or more locations of the one or more annotations based on one or more locations of the one or more points of interest. The one or more locations can comprise one or more locations relative to the point of interest (e.g., to the left of the point of interest, above the point of interest, to the right of the point of interest, or below the point of interest). Further, the one or more location of the one or more annotations can be in the foreground or background relative to a point of interest. For example, the one or more annotations can be generated within a three-dimensional model of a structure associated with a point of interest that corresponds to a position that is two meters above the point of interest in the physical environment.

In some embodiments, the plurality of three-dimensional models of structures can be associated with one or more bounding boxes. Further, the one or more annotations can be located at one or more centroids of the one or more bounding boxes associated with the one or more points of interest. For example, if an annotation is included in a rectangle and a three-dimensional model of a building is forty meters wide and eighty meters tall, the annotation can appear at approximately the center point of the building that is approximately forty meters high and approximately twenty meters from the left and right edges of the building.

The computing system can generate modified view data (e.g., view data comprising and/or associated with one or more two-dimensional images, an augmented reality environment, and/or a virtual reality environment) based on the view data and/or the one or more annotations. For example, the modified view data can comprise the view data and/or the one or more annotations (e.g., the one or more annotations can be superimposed over the representation of the physical environment of the view data). Further, the view data can comprise an annotated two-dimensional image of the physical environment that includes the one or more annotations, a video stream comprising the one or more annotations, and/or a three-dimensional representation of the physical environment.

In some embodiments, the view data can comprise a two-dimensional image of the physical environment. Further, the computing system can generate an annotated two-dimensional image of the physical environment based on the view data comprising the two-dimensional image of the physical environment and/or the one or more annotations. For example, if the two-dimensional image of the environment comprises an image of a statue in a park, the computing system can generate an annotated two-dimensional image that includes the two-dimensional image of the statue and one or more annotations above the statue.

In some embodiments, the computing system can generate an augmented reality environment based on view data comprising the video stream and the one or more annotations. For example, the computing system can generate an augmented reality environment that is based on an appearance of a physical environment detected by an augmented reality device (e.g., an augmented reality based on a view of an urban environment captured by cameras of augmented reality glasses). Further, the augmented reality environment can superimpose the one or more annotations near the locations of points of interest that are in the field of view of the augmented reality device.

In some embodiments, the view data can comprise a three-dimensional representation of the physical environment. Further, surfaces of the three-dimensional representation of the physical environment can be based on images of corresponding surfaces of the physical environment. The computing system can generate a virtual reality environment based on the view data comprising the three-dimensional representation of the physical environment and/or the one or more annotations. For example, the computing system can generate a virtual reality environment that is based on the appearance of a physical environment. Further, the virtual reality environment can generate the one or more annotations in proximity to the locations of points of interest that are in the field of view of the virtual reality device.

In some embodiments, generating the visibility data and/or the one or more annotations can be performed by one or more machine-learned models. The one or more machine-learned models can comprise one or more convolutional neural networks. Further, the one or more machine-learned models can be configured and/or trained to generate point of interest data comprising one or more points of interest and/or annotation data comprising one or more annotations. The computing system can receive training data. The training data can comprise training map data, training visibility data, training view data, training point of interest data, and/or training annotation data. The training map data can comprise a plurality of three-dimensional training models of structures in a physical environment and/or an artificial environment (e.g., an artificially generated environment that is designed to have features of real physical environments). The training visibility data can comprise a plurality of training visibility cells associated with a plurality of training map projection cells that correspond to a plurality of locations in a physical environment and/or artificial environment. The training view data can comprise a plurality of training visual representations of physical environments that are visible from a location associated with a physical environment. Further, the training view data can comprise a plurality of training visual representations of artificial environments that are visible from a location associated with an artificial environment. The training point of interest data can comprise a plurality of training points of interest that are associated with locations in a physical environment and/or artificial environment. Further, the training annotation data can comprise a plurality of training annotations associated with a plurality of points of interest that are visible from the training map projection cells associated with a physical environment and/or artificial environment.

In some embodiments, the training data can comprise a plurality of embeddings. The plurality of embeddings can comprise a lower-dimensionality vector space representation of the training data. For example, the view data can be represented in a lower-dimensional vector space that can preserve information about the visual features of images and/or video associated with view data in a lower-dimensionality vector space than the higher-dimensionality vector space of the original images and/or video in the view data (e.g., a higher-dimensionality vector space that can include information about every pixel of the training images and/or frame of the training video). The plurality of embeddings can be arranged such that semantically similar embeddings are closer together in the vector space.

Further, training the one or more machine-learned models can comprise generating and/or determining, based on inputting the training data into the one or more machine-learned models, output comprising a plurality of predicted outputs. The plurality of predicted outputs can comprise a plurality of predicted points of interest and/or a plurality of predicted annotations. For example, based on the received input, the one or more machine-learned models can perform one or more operations (e.g., one or more detection operations, one or more recognition operations, and/or one or more classification operations) and generate an output comprising a plurality of predicted points of interest and/or a plurality of predicted annotations.

The output of the one or more machine-learned models can be evaluated based on one or more comparisons of the plurality of predicted points of interest to a corresponding plurality of ground-truth points of interest associated with the training data (e.g., ground-truth points of interest based on the same map data, view data, and/or visibility data as the corresponding predicted points of interest). Further, the output of the one or more machine-learned models can be evaluated based on one or more comparisons of the plurality of predicted annotations to a corresponding plurality of ground-truth annotations associated with the training data (e.g., ground-truth annotations based on the same map data, view data, and/or visibility data as the corresponding plurality of predicted annotations).

Training the one or more machine-learned models can comprise determining a loss based on one or more differences between the plurality of predicted outputs and a corresponding plurality of ground-truth outputs. Training the one or more machine-learned models can comprise determining a loss based on one or more differences between the plurality of predicted points of interest and the plurality of ground-truth points of interest. Further, training the one or more machine-learned models can comprise determining a loss based on one or more differences between the plurality of predicted annotations and the plurality of ground-truth annotations.

A loss function can be used to determine the loss. Further, the loss function can be used to evaluate one or more differences between the plurality of predicted annotations and the plurality of ground-truth annotations. The loss can increase in proportion to the number of the one or more differences between the plurality of predicted annotations and the plurality of ground-truth annotations. For example, if a predicted annotation and the corresponding ground-truth annotation are associated with different points of interest and/or have major differences in appearance and/or location, the loss can be greater than if the predicted annotation is associated with the same points of interest as the ground-truth annotation and has minor differences in appearance and/or location.

Further, the loss can increase in proportion to the magnitude of differences between the plurality of predicted outputs and the plurality of ground-truth outputs. The loss can increase in proportion to the magnitude of differences between the plurality of predicted points of interest and the plurality of ground-truth points of interest. Further, the loss can increase in proportion to the magnitude of differences between the plurality of predicted annotations and the plurality of ground-truth annotations. For example, a predicted annotation that is based on the same training view data as a corresponding ground-truth annotation that does not match a corresponding ground-truth annotation and is positioned in a location one hundred meters away from the ground-truth annotation can result in a greater loss than a predicted annotation that matches a corresponding ground-truth annotation and is positioned in a location that is five meters away from the ground-truth annotation.

Training the one or more machine-learned models can comprise modifying a plurality of parameters of the one or more machine-learned models to minimize the loss. The plurality of parameters can be associated with detection, recognition, and/or classification of one or more features of the training data that can be used to determine the plurality of predicted points of interest and/or the plurality of predicted annotations. Further, the plurality of parameters can be associated with a plurality of weights that can be associated with an extent to which the plurality of parameters contribute to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of predicted points of interest such that parameters that are more heavily weighted can contribute more to determining the predicted points of interest than parameters that are less heavily weighted. Further, the plurality of weights of the plurality of parameters can be associated with the plurality of predicted annotations such that parameters that are more heavily weighted can contribute more to determining the predicted annotations than parameters that are less heavily weighted.

Over the plurality of iterations, the weights of the plurality of parameters can be modified to minimize the loss until a threshold loss that corresponds to a high accuracy of the one or more machine-learned models determining the plurality of predicted points of interest and/or the plurality of predicted annotations is achieved. For example, the loss can be minimized until a threshold loss associated with 99% accuracy is achieved by the machine-learned model.

The systems, methods, devices, and/or computer-readable media (e.g., tangible non-transitory computer-readable media) in the disclosed technology can provide a variety of technical effects and benefits including an improvement in the determination of the visibility of structures in a physical environment and an improvement in the generation of annotations that can be used to assist navigation. For example, the disclosed technology can improve the effectiveness and safety of navigation by improving the determination of points of interest that may be distant from a user’s location, thereby reducing the probability of a user becoming lost. Providing a user with more accurate annotations that indicate points of interest (e.g., a hospital) may reduce the probability that a user will lose track of their location due to unclear and/or ambiguous annotations.

The disclosed technology can generate visibility data that comprises visibility cells that indicate the visibility of portions of three-dimensional models of structures in a physical environment from various locations in the physical environment. Precomputing the visibility cells can reduce the computational burden on a computing device (e.g., a mobile computing device that implements a map application and/or generates an augmented reality environment) as well as allowing the determination of visible points of interest to be performed more effectively. Additionally, precomputing the visibility cells can reduce the latency associated with generating annotations in an augmented reality environment. By sending precomputed visibility cells associated with the visibility of points of interest in an area to the computing device in advance, the computing device can generate annotations in an augmented reality environment more rapidly.

By determining the visibility of points of interest in an environment based on the performance of surface visibility operations that can comprise ray casting to determine visibility cells associated with the visibility of three-dimensional models of structures in a physical environment, the disclosed technology can determine more accurate locations for annotations. As a result of the more accurate placement of annotations, the locations of points of interest can be more effectively determined and navigation can be improved.

The disclosed technology can also improve the effectiveness with which network resources are used by precomputing the visibility of points of interest from locations in a physical environment. By performing what may be computationally expensive operations to determine the visibility of points of interest from a location, a local device (e.g., a mobile device) may more quickly determine visible points of interest and reduce the excessive battery drain that may result from performing the operations on-device.

As such, the disclosed technology can allow the user of a computing system to perform the technical task of determining the visibility of structures in an environment and generating annotations. As a result, users can be provided with the specific benefits of improved performance (visibility determination performance and/or annotation generation performance), a reduction in navigation errors, and more efficient use of system resources. Further, any of the specific benefits provided to users can be used to improve the effectiveness of a wide variety of devices and services including services that determine visibility and/or generate annotations. Accordingly, the improvements offered by the disclosed technology can result in tangible benefits to a variety of devices and/or systems including mechanical, electronic, and computing systems associated with determining visibility and/or generating annotations.

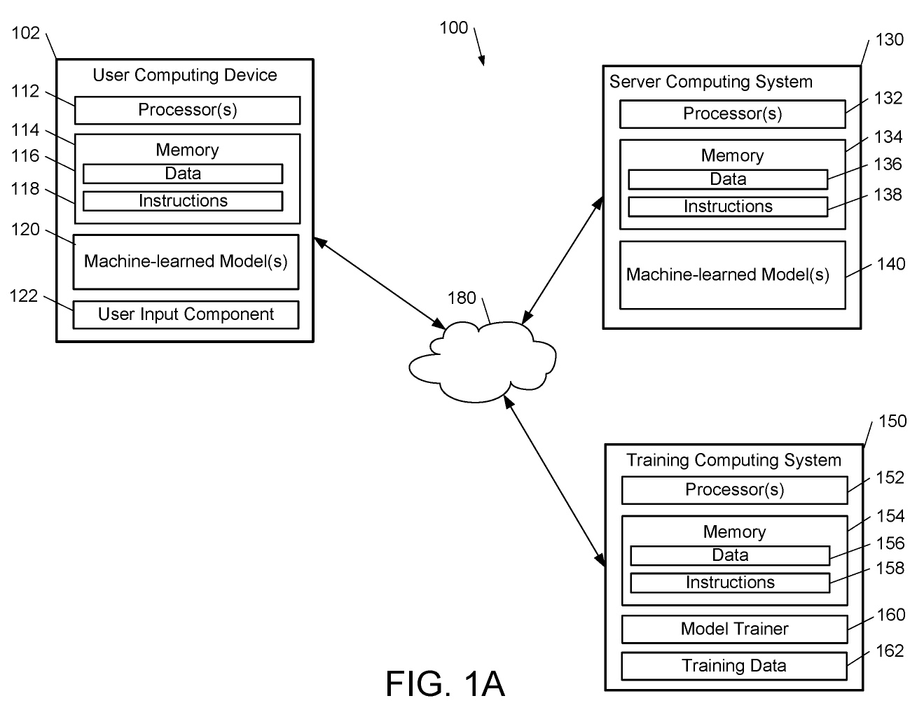

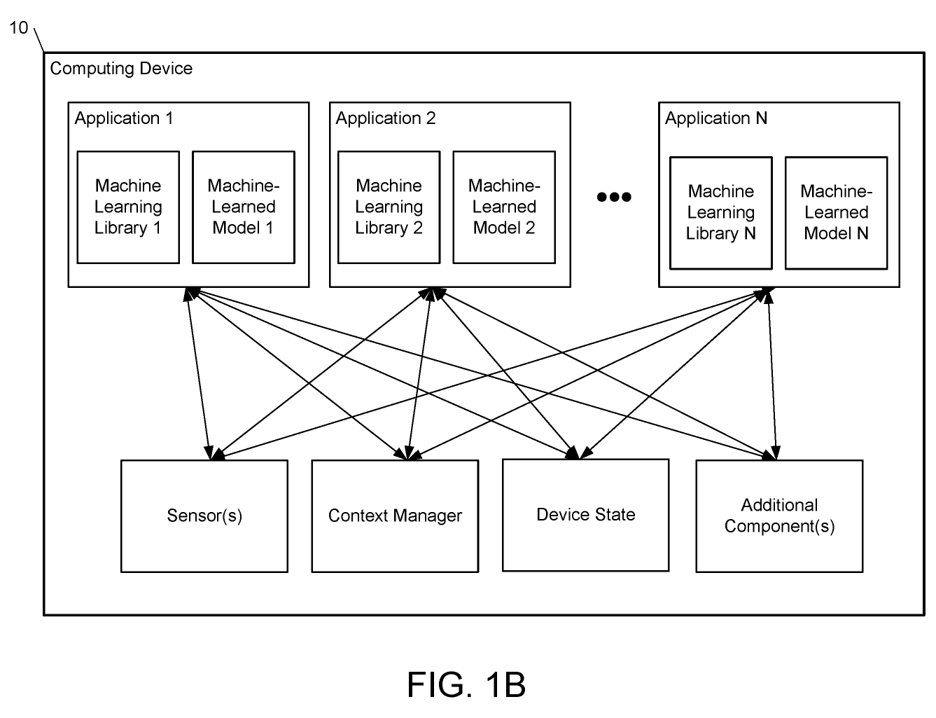

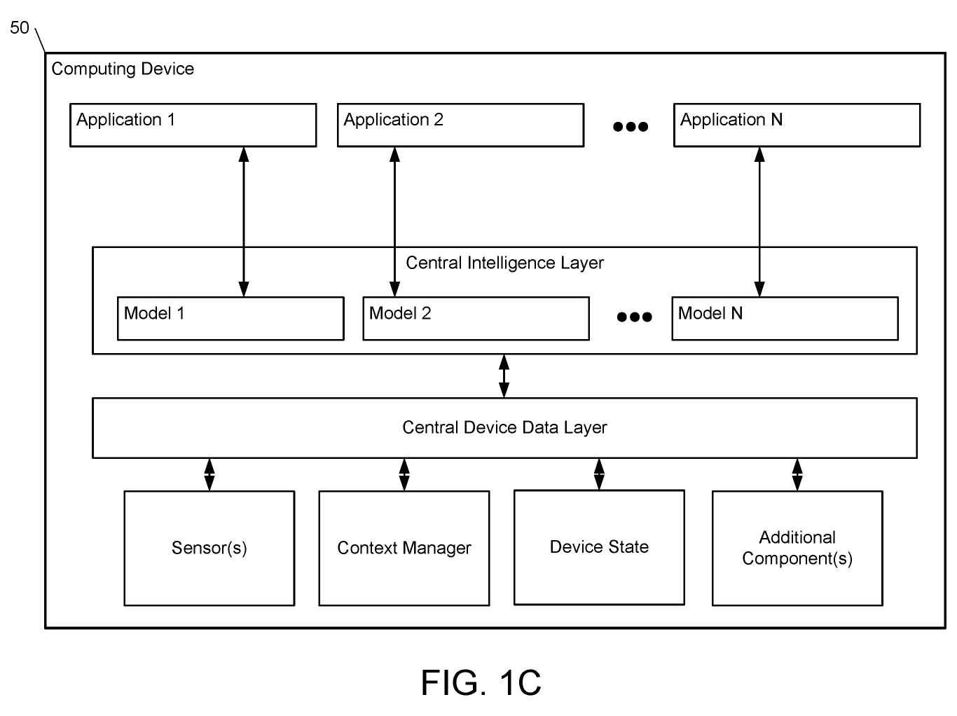

With reference now to the figures, example embodiments of the present disclosure will be discussed in further detail. FIG. 1A depicts a block diagram of an example computing system that can determine the visibility of structures in an environment according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can be any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Further, the one or more machine-learned models 120 can comprise one or more large language models (LLMs), one or more generative adversarial networks (GANs), one or more retrieval augmented generation models (RAGs), one or more encoders, one or more decoders, one or more auto-encoders, and/or one or more embedding models. Examples of one or more machine-learned models 120 are discussed with reference to FIGS. 1-10.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel visibility determination and/or annotation generation operations across multiple instances of the one or more machine-learned models 120).

More particularly, the one or more machine-learned models 120 can comprise one or more machine-learned models (e.g., one or more auto-encoders) that are configured and/or trained to perform operations comprising receiving map data comprising three-dimensional models of structures in a physical environment, determining portions of the three-dimensional models of structures that are visible from each map projection cell of a plurality of map projection cells that correspond to locations in the physical environment, generating visibility data comprising visibility cells associated with the map projection cells, receiving view data comprising information associated with a visual representation of the physical environment that is visible from a location in the physical environment, determining the visibility cell that is associated with the location in the physical environment, determining points of interest associated with the visibility cell, and/or generating annotations based on the points of interest that are visible from the map projection cell associated with the location.

Additionally or alternatively, one or more machine-learned models 140 can be included in or otherwise stored and implemented by the server computing system 130 that communicates with the computing device 102 according to a client-server relationship. For example, the one or more machine-learned models 140 can be implemented by the server computing system 130 as a portion of a web service (e.g., a visibility determination and/or annotation generation service). Thus, one or more machine-learned models 120 can be stored and implemented at the computing device 102 and/or one or more machine-learned models 140 can be stored and implemented at the server computing system 130.

The computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger and/or stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an NPU, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include auto-encoders, neural networks, and/or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-10.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained.

In particular, the model trainer 160 can train the one or more machine-learned models 120 and/or the one or more machine-learned models 140 based on a set of training data 162. The training data 162 can include various types of data. For example, the training data 162 can comprise training map data, training visibility data, training view data, training point of interest data, and/or training annotation data. The model trainer 160 can train and/or retrain the one or more machine-learned models 120 and/or the one or more machine-learned models 140 based on additional data from the training data 162. For example, the additional training data can comprise additional map data (e.g., updated map data), new types of map data (e.g., new types of map data comprising new types of two-dimensional map data and/or new types of three-dimensional map data), and/or one or more modifications to existing map data.

In some implementations, if a user has provided consent (e.g., the user provides affirmative consent for another party to use the user’s data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification can be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an output comprising images of a physical environment and annotations associated points of interest in the physical environment). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data sources. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task can be an audio compression task. The input can include audio data and the output can comprise compressed audio data. In another example, the input includes visual data (e.g., one or more images or videos), the output comprises compressed visual data, and the task is a visual data compression task. In another example, the task can comprise generating an embedding for input data (e.g., input audio data or visual data).

In some cases, the input includes audio data representing a spoken utterance and the task is a speech recognition task. The output can comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example computing device that can determine the visibility of structures in an environment according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include a map data processing application, a visibility data generation application, a view data processing application, a point of interest data processing application, an annotation generation application, a social media application, a text messaging application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that can determine the visibility of structures in an environment according to example embodiments of the present disclosure. A computing device 50 can be a user computing device or a server computing device.

The computing device 50 includes a number of applications (e.g., applications 1 through N). Each application is in communication with a central intelligence layer. Example applications include a map processing application (e.g., an application that is used to receive and/or process map data), a visibility data generation application (e.g., an application that is used to generate visibility data based on map data), a view data processing application (e.g., an application that is used to receive and/or process view data), a point of interest data processing application (e.g., an application that is used to receive and/or process point of interest data), an annotation generation application (e.g., an application that is used to generate annotations based on visibility data, view data, and/or point of interest data), a text messaging application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

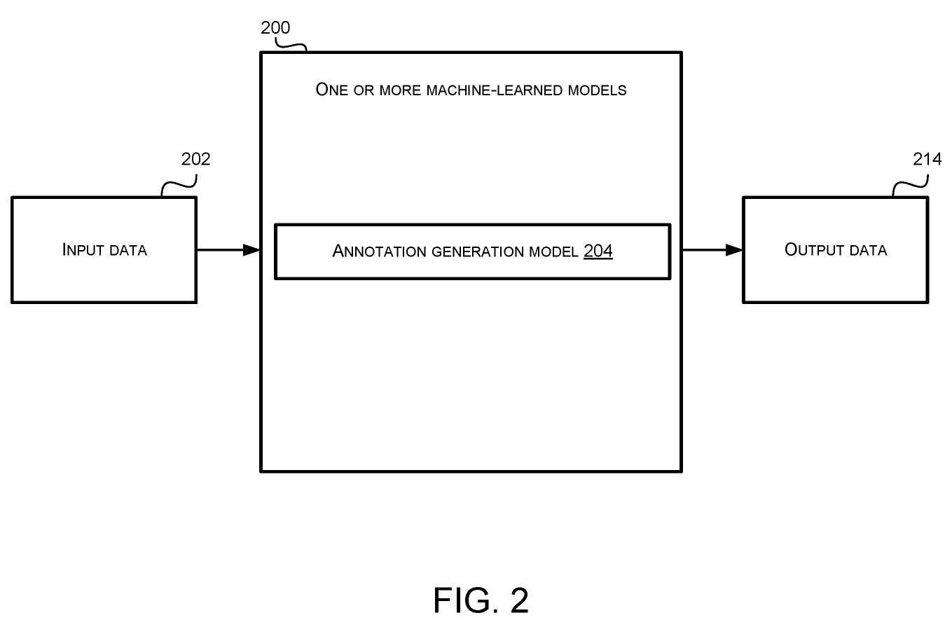

FIG. 2 depicts a block diagram of examples of machine-learned models according to example embodiments of the present disclosure. In some implementations, the one or more machine-learned models 200 can be trained to receive input data 202 that can comprise map data, visibility data, view data, point of interest data, and/or annotation data associated with one or more annotations. As a result of receipt of the input data 202 the one or more machine-learned models 200 can generate output data 214 that can comprise one or more annotations.

In some implementations, the one or more machine-learned models 200 can include an annotation generation model 204 that is operable to generate one or more annotations based on the input data 202 (e.g., input data comprising map data, visibility data, view data, point of interest data).

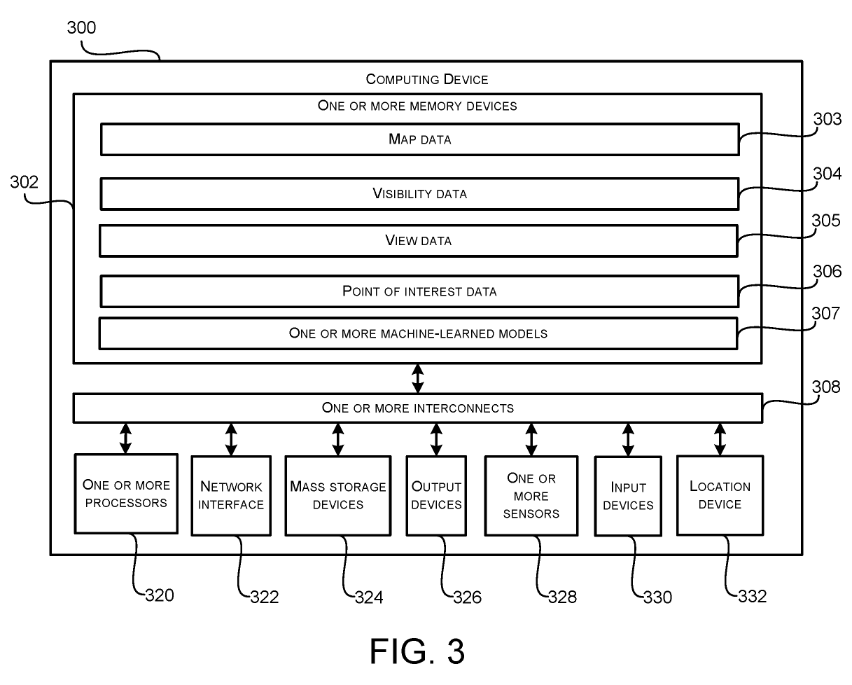

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, map data 303, visibility data 304, view data 305, point of interest data 306, one or more machine-learned models 307, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device, a mobile computing device (e.g., a smartphone, tablet computing device, and/or laptop computing device), an augmented reality device (e.g., augmented reality glasses and/or an augmented reality headset), an extended reality device (e.g., extended reality glasses and/or an extended reality headset), and/or a virtual reality device (e.g., a virtual reality headset). Further, the computing device 300 can process and/or generate data (e.g., visibility data) based on data (e.g., map data) of the computing device 300 and/or data that is received from another computing device (e.g., map data that is generated by a remote computing device). Further, the computing device 300 can process and/or generate data (e.g., annotation data associated with one or more annotations) based on data (e.g., map data, visibility data, view data, and/or point of interest data) of the computing device 300 and/or data that is received from another computing device (e.g., map data that is generated by a remote computing device).

The one or more memory devices 302 can store information and/or data (e.g., the map data 303, the visibility data 304, the view data 305, the point of interest data 306 and/or the one or more machine-learned models 307). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including receiving map data comprising three-dimensional models of structures in a physical environment, determining portions of the three-dimensional models of structures that are visible from each map projection cell of a plurality of map projection cells that correspond to locations in the physical environment, generating visibility data comprising visibility cells associated with the map projection cells, receiving view data comprising information associated with a visual representation of the physical environment that is visible from a location in the physical environment, determining the map projection cell and visibility cell that are associated with the location in the physical environment, determining points of interest associated with the visibility cell, and/or generating annotations based on the points of interest that are visible from the map projection cell associated with the location.

The map data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. The map data 303 can comprise information associated with one or more physical environments. Further, the map data 303 can comprise a plurality of three-dimensional models of structures in a physical environment. In some embodiments, the map data 303 can be received from one or more computing systems (e.g., the server computing system 130 that is depicted in FIG. 1A) which can include one or more computing systems that are remote from the computing device 300. Further, the map data 303 can comprise one or more instructions that can be used by the computing device 300 and/or another computing device to perform operations. For example, the map data 303 can be associated with a map application and can comprise instructions to determine geographic locations and/or retrieve map data for the geographic locations.

The visibility data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. In some embodiments, the visibility data 304 can be received from one or more computing systems (e.g., the server computing system 130 that is depicted in FIG. 1A) which can include one or more computing systems that are remote from the computing device 300. The visibility data 304 can comprise information associated with visibility cells that are associated with map projection cells that correspond to locations of a physical environment indicated in the map data 303. The visibility data 304 can indicate one or more portions of the three-dimensional models of the map data 303 that are visible from a map projection cell.

The view data 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the view data 305 can include information associated with a visual representation of the physical environment that is visible from a location in the physical environment. In some embodiments, the view data 305 can be received from one or more computing systems (e.g., the server computing system 130 that is depicted in FIG. 1A) which can include one or more computing systems that are remote from the computing device 300.

The point of interest data 306 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the point of interest data 306 can include information associated with points of interest that are associated with a map projection cell and/or visibility cell. For example, the points of interest indicated in the point of interest data 306 can comprise salient areas such as landmarks, parks, and/or historical sites. In some embodiments, the point of interest data 306 can be received from one or more computing systems (e.g., the server computing system 130 that is depicted in FIG. 1A) which can include one or more computing systems that are remote from the computing device 300.

The one or more machine-learned models 307 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 307 can be configured and/or trained to perform operations comprising receiving map data comprising three-dimensional models of structures in a physical environment, determining portions of the three-dimensional models of structures that are visible from each map projection cell of a plurality of map projection cells that correspond to locations in the physical environment, generating visibility data comprising visibility cells associated with the map projection cells, receiving view data comprising information associated with a visual representation of the physical environment that is visible from a location in the physical environment, determining the map projection cell and visibility cell that are associated with the location in the physical environment, determining points of interest associated with the visibility cell, and/or generating annotations based on the points of interest that are visible from the map projection cell associated with the location. In some embodiments, the one or more machine-learned models 307 can be received from one or more computing systems (e.g., the server computing system 130 that is depicted in FIG. 1A) which can include one or more computing systems that are remote from the computing device 300.

The one or more interconnects 308 can include one or more interconnects or buses that can be used to send and/or receive one or more signals (e.g., electronic signals) and/or data (e.g., the map data 303, the visibility data 304, the view data 305, the point of interest data 306, and/or the one or more machine-learned models 307) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the map data 303, the visibility data 304, the view data 305, the point of interest data 306, and/or the one or more machine-learned models 307. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., map data) from other computing devices. The one or more mass storage devices 324 (e.g., a hard disk drive and/or a solid-state drive) can be used to store data including the map data 303, the visibility data 304, the point of interest data 306, and/or the one or more machine-learned models 307.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on the map data 303, the visibility data 304, the view data 305, and/or the point of interest data 306.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the visibility data 304. The one or more memory devices 302 can be used to operate various applications including a mobile operating system developed specifically for mobile devices. As such, the one or more memory devices 302 can store instructions that allow the software applications to access data including data associated with the determination of visibility and the generation of annotations. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

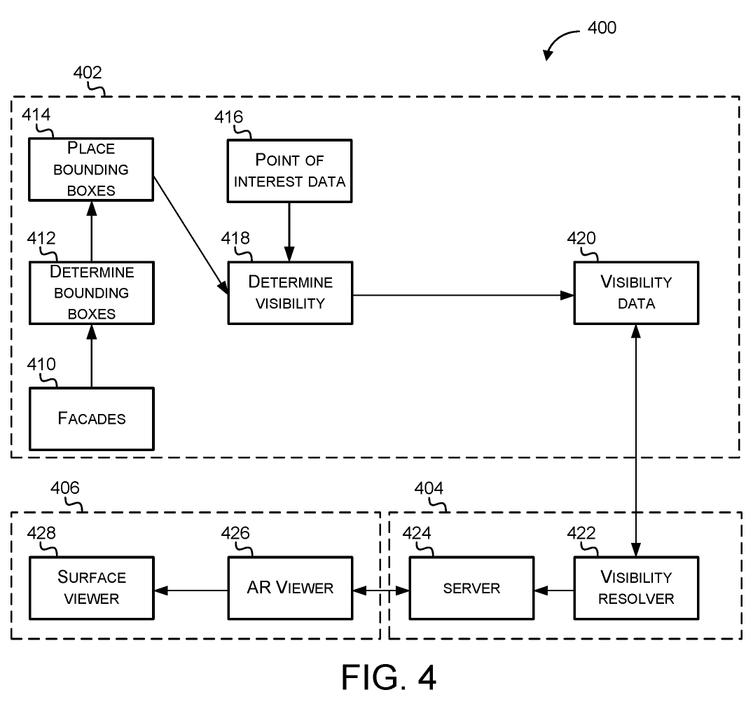

FIG. 4 depicts a diagram of a computing system configured to determine the visibility of structures in an environment according to example embodiments of the present disclosure. A computing system 400 can include one or more features and/or capabilities of the computing device 102, the server computing system 130, the training computing system 150, and/or the computing device 300. Furthermore, the computing system 400 can perform one or more actions and/or operations that can be performed by the computing device 102, the server computing system 130, the training computing system 150, and/or the computing device 300.

The computing system 400 can comprise a computing device 402, a computing device 404, a computing device 406, facade generation operations 410, bounding box determination operations 412, bounding box placement operations 414, point of interest data 416, visibility determination operations 418, visibility data 420, visibility resolver 422, server 424, augmented reality viewer 426, and surface viewer 428.

The computing device 402 (e.g., a computing system that is configured to process and/or generate visibility data and/or point of interest data) can perform the facade generation operations 410 to generate facades that are based on a plurality of three-dimensional models of structures in physical environments (e.g., three-dimensional models of a physical environment comprising a city that has various structures including buildings). In some embodiments, the facades can comprise surfaces that are associated with images of physical structures in a physical environment.

Further, the computing device 402 can perform the bounding box determination operations 412 to determine bounding boxes for each of the facades generated in the facade generation operations 410. The bounding boxes determined in the bounding box determination operations 412 may reduce the complexity of the surfaces of the three-dimensional models of structures based on the physical environment. For example, the rectangular cuboid bounding box for a building in a physical environment can have similar dimensions (e.g., the bounding box can have a height, width, and depth that are similar to the building), but with flat surfaces in place of the ridges, grooves, and surface ornamentations of the actual building in the physical environment.

The bounding box placement operations 414 can comprise the computing device 402 placing the bounding boxes around the three-dimensional models of structures. The bounding boxes can be placed such that the bounding boxes enclose the three-dimensional models of structures. The visibility determination operations 418 can comprise operations to determine the visibility of the three-dimensional models of structures from various locations (e.g., geographic coordinates and/or map projection cells corresponding to locations in the physical environment). Determining the visibility of the three-dimensional models of structures can comprise determining visibility cells that indicate visible portions of the three-dimensional models of structures. For example, the visibility determination operations can comprise one or more ray casting operations to determine visibility of the three-dimensional models of structures from various locations. Further, the visibility determination operations 418 can comprise accessing point of interest data 416 that includes information associated with locations of points of interest and/or the three-dimensional models of structures that are points of interest. Based on the point of interest data 416 and/or the visibility determination operations 418, the computing device 402 can generate the visibility data 420 that can comprise the plurality of visibility cells.

The computing device 406 (e.g., a client device which can comprise a smartphone or augmented reality headset) can communicate (e.g., send data and/or receive data) with the computing device 404 (e.g., a server device that can be configured to send data based on the visibility data 420, to the computing device 406). The computing device 406 can comprise the augmented reality viewer 426 can implement an augmented reality application that can generate an augmented reality environment comprising annotations associated with visible portions of a physical environment. The augmented reality viewer 426 can send a request to the server 424 which can communicate with the visibility resolver 422 which can retrieve visibility data 420 that is associated with the location of the device 406 that implements the augmented reality viewer 426. The server 424 can receive a portion of the visibility data 420 that is relevant to the augmented reality viewer 426 (e.g., a portion of the visibility data 420 that is associated with the location of the computing device 406) from the visibility resolver 422 and send the visibility data 420 to the augmented reality viewer 426 which can generate annotations based on the visibility data 420. For example, the augmented reality viewer 426 can generate modified view data that comprises view data (e.g., a video stream) and annotations generated based on the visibility data 420 that is associated with the location of the computing device 406.

Further, the surface viewer 428 can send a request to the server 424 which can communicate with the visibility resolver 422 which can retrieve visibility data 420 that is associated with the location of the device 406 that implements the surface viewer 428. The server 424 can receive a portion of the visibility data 420 that is relevant to the surface viewer 428 (e.g., a portion of the visibility data 420 that is associated with the location of the computing device 406) from the visibility resolver 422 and send the visibility data 420 to the surface viewer 428 which can generate annotations based on the visibility data 420. For example, the surface viewer 428 can generate modified view data that comprises view data (e.g., two-dimensional images) and annotations generated based on the visibility data 420 that is associated with the location of the computing device 406.

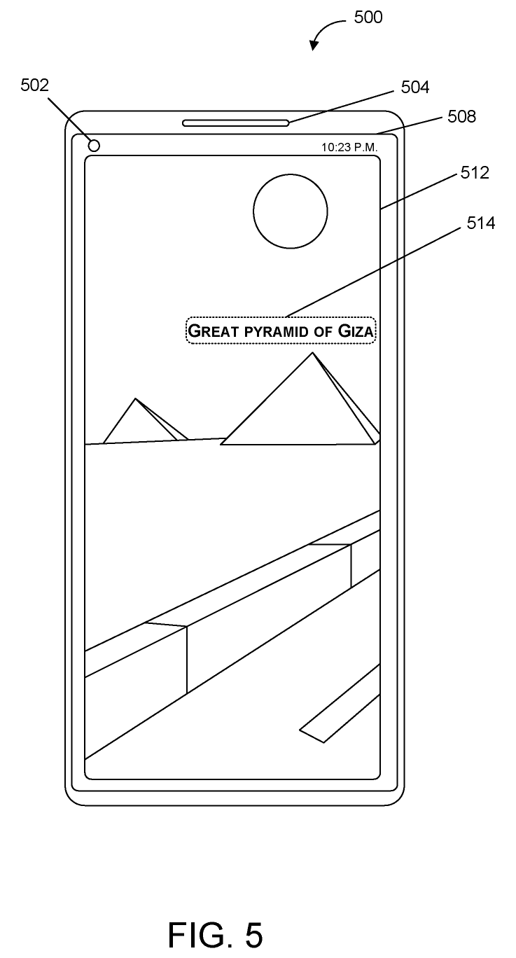

FIG. 5 depicts an example of an interface for displaying annotations of visible structures in an environment according to example embodiments of the present disclosure. The computing device 500 can comprise one or more features and/or capabilities of the computing device 102, the server computing system 130, the training computing system 150, and/or the computing device 300.

The computing device 500 can include an image capture component 502, an audio output component 504, a display component 508, an interface 512, and an indication 514.

The computing device 500 (e.g., a smartphone) can be configured to perform one or more operations comprising sending, receiving, processing, and/or generating data comprising map data (e.g., map data comprising three-dimensional models of structures in a physical environment), visibility data (e.g., visibility data associated with portions of a physical environment corresponding to a three-dimensional model of the physical environment that are visible from a location), view data (e.g., view data captured by the image capture component of the computing device such as the image capture component 502), point of interest data (e.g., data associated with points of interest including archeological sites and historical landmarks), and/or other data received or stored by the computing device 500.

The computing device 500 can comprise the image capture component 502 (e.g., a front facing camera) that can be used to generate view data based on capturing images and/or video of a physical environment (e.g., a desert environment). In some embodiments, an image capture component (e.g., a rear facing camera) of the computing device 500 component can be used to generate view data comprising still images and/or video (e.g., motion images) of the physical environment (e.g., the desert and great pyramids of Giza) displayed in the interface 512.

In this example, a portion of the physical environment around the computing device 500 has been captured by a rear facing image capture component (not shown) of the computing device 500. As part of determining points of interest that are displayed in the interface 512 of the display component 508, the computing device 500 can determine the location (e.g., geographic location) of the computing device 500. For example, the computing device 500 can use global satellite positioning data, cellular tower triangulation, location beacons, detection of images of the physical environment, and/or recognition of images of the physical environment to determine the location of the computing device 500.

Based on the determination of the location of the location of the computing device 500, the computing device 500 can determine a map projection cell corresponding to the location. Further, the computing device 500 can access visibility data (e.g., visibility data that can be locally stored and/or remotely stored) and determine based on map data comprising a plurality of three-dimensional models of structures in the physical environment, one or more portions of the plurality of three-dimensional models of structures that are visible from the map projection cell.

The computing device can then access point of interest data to determine one or more points of interest that are visible from the map projection cell. Based on determining a point of interest (e.g., the great pyramid of Giza), the computing device can generate the indication 514 which indicates “GREAT PYRAMID OF GIZA” above the image of the great pyramid of Giza that is displayed in the interface 512. In some embodiments, the audio output component 504 can be used to generate audio indications (e.g., synthetic speech) to indicate the location of points of interest that are in a field of view of the computing device 500. For example, the computing device 500 can generate audio indicating “THE GREAT PYRAMID OF GIZA IS 500 METERS STRAIGHT AHEAD OF YOU.”

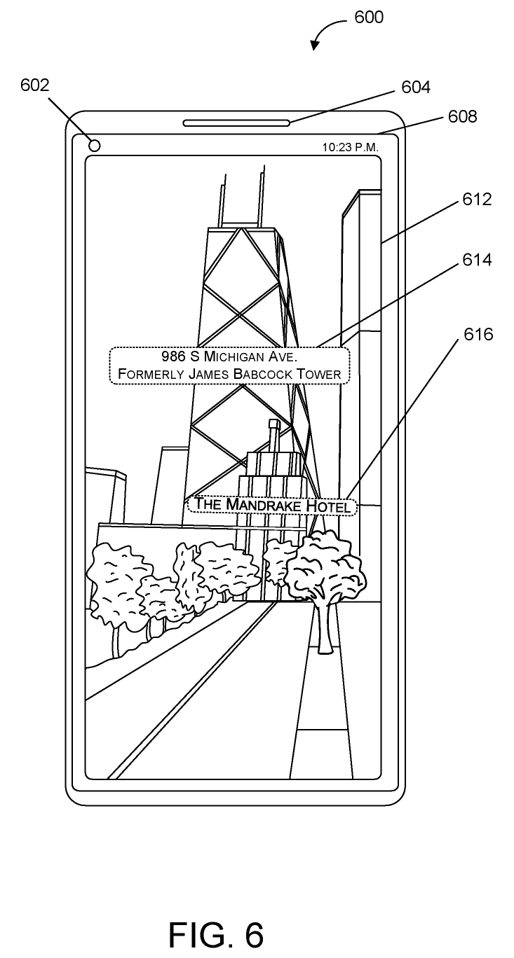

FIG. 6 depicts an example of an interface for displaying annotations of visible structures in an environment according to example embodiments of the present disclosure. The computing device 600 can comprise one or more features and/or capabilities of the computing device 102, the server computing system 130, the training computing system 150, and/or the computing device 300.

The computing device 600 can include an image capture component 602, an audio output component 604, a display component 608, an interface 612, an indication 614, an indication 616, and/or an indication 618.

The computing device 600 (e.g., a smartphone) can be configured to perform one or more operations comprising sending, receiving, processing, and/or generating data comprising map data (e.g., map data comprising three-dimensional models of structures in a physical environment), visibility data (e.g., visibility data associated with portions of a physical environment corresponding to a three-dimensional model of the physical environment that are visible from a location), view data (e.g., view data captured by the image capture component of the computing device such as the image capture component 602), point of interest data (e.g., data associated with points of interest including physically prominent and/or culturally significant buildings), and/or other data received or stored by the computing device 600.

The computing device 600 can comprise the image capture component 602 (e.g., a front facing camera) that can be used to generate view data based on capturing images and/or video of a physical environment (e.g., an urban environment). In some embodiments, an image capture component (e.g., a rear facing camera) of the computing device 600 component can be used to generate view data comprising still images and/or video (e.g., motion images) of the physical environment (e.g., buildings in a city) displayed in the interface 612.

In this example, a portion of the physical environment around the computing device 600 has been captured by a rear facing image capture component (not shown) of the computing device 600. As part of determining points of interest that are displayed in the interface 612 of the display component 608, the computing device 600 can determine the location (e.g., geographic location) of the computing device 600.

Based on the determination of the location of the location of the computing device 600, the computing device 600 can determine a map projection cell corresponding to the location. Further, the computing device 600 can access visibility data (e.g., visibility data that can be locally stored and/or remotely stored) and determine based on map data comprising a plurality of three-dimensional models of structures in the physical environment, one or more portions of the plurality of three-dimensional models of structures that are visible from the map projection cell.

The computing device can then access point of interest data to determine one or more points of interest that are visible from the map projection cell. Based on determining points of interest (e.g., “986 S Michigan Ave” and the “The Mandrake Hotel”), the computing device can generate the indication 614 which indicates “986 S MICHIGAN AVE. FORMERLY JAMES BABCOCK TOWER” above the image of the 986 S Michigan Ave. building that is displayed in the interface 612. The indication 614 includes the current name of the point of interest (e.g., “986 S MICHIGAN AVE.”) as well as the former name of the point of interest (e.g., the “JAMES BABCOCK TOWER”). The indication 614 can be located near a centroid of the point of interest with which the indication 614 is associated. Further, the indication 616 indicates another point of interest, the “THE MANDRAKE HOTEL” which is generated in a separate portion of the interface 612 from the indication 614, thereby emphasizing the distinction between the points of interest associated with the indication 614 and the indication 616.

In some embodiments, the audio output component 604 can be used to generate audio indications (e.g., synthetic speech) to indicate the location of points of interest that are in a field of view of the computing device 600. For example, the computing device 600 can generate audio indicating “THE 986 S MICHIGAN AVE. BUILDING IS IN FRONT OF YOU” or “THE MANDRAKE HOTEL IS IN FRONT OF YOU.”

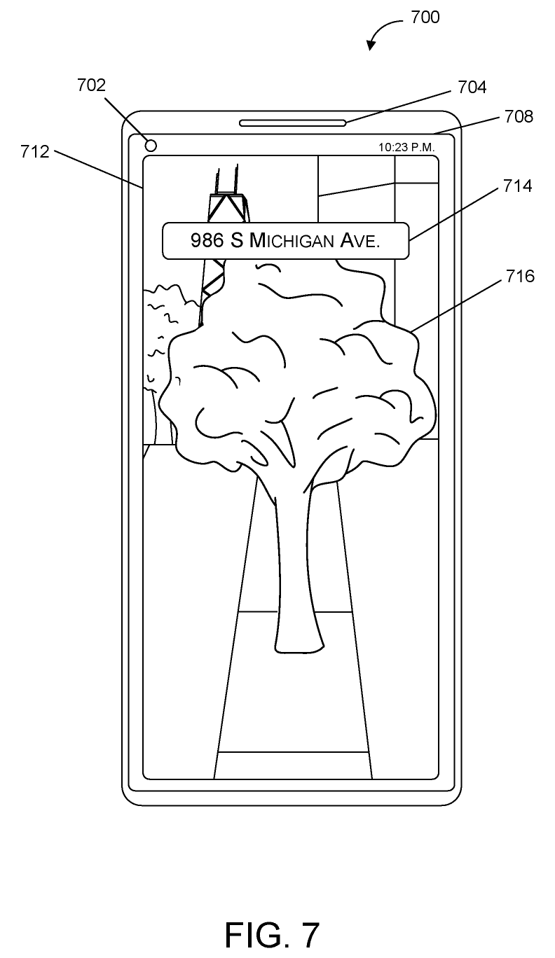

FIG. 7 depicts an example of an interface for displaying annotations of visible structures in an environment according to example embodiments of the present disclosure. The computing device 700 can comprise one or more features and/or capabilities of the computing device 102, the server computing system 130, the training computing system 150, and/or the computing device 300.

The computing device 700 can include an image capture component 702, an audio output component 704, a display component 708, an interface 712, an indication 714, and/or an object 716.

The computing device 700 (e.g., a smartphone) can be configured to perform one or more operations comprising sending, receiving, processing, and/or generating data comprising map data (e.g., map data comprising three-dimensional models of structures in a physical environment), visibility data (e.g., visibility data associated with portions of a physical environment corresponding to a three-dimensional model of the physical environment that are visible from a location), view data (e.g., view data captured by the image capture component of the computing device such as the image capture component 702), point of interest data (e.g., data associated with points of interest including tourist attractions), and/or other data received or stored by the computing device 700.

The computing device 700 can comprise the image capture component 702 (e.g., a front facing camera) that can be used to generate view data based on capturing images and/or video of a physical environment (e.g., a city environment). In some embodiments, an image capture component (e.g., a rear facing camera) of the computing device 700 component can be used to generate view data comprising still images and/or video (e.g., motion images) of the physical environment (e.g., the city streets and buildings including the 986 S Michigan Ave. building) displayed in the interface 712.

In this example, a portion of the physical environment around the computing device 700 has been captured by a rear facing image capture component (not shown) of the computing device 700. As part of determining points of interest that are displayed in the interface 712 of the display component 708, the computing device 700 can determine the location (e.g., geographic location) of the computing device 700.

Based on the determination of the location of the location of the computing device 700, the computing device 700 can determine a map projection cell corresponding to the location. Further, the computing device 700 can access visibility data (e.g., visibility data that can be locally stored and/or remotely stored) and determine based on map data comprising a plurality of three-dimensional models of structures in the physical environment, one or more portions of the plurality of three-dimensional models of structures that are visible from the map projection cell.

The computing device can then access point of interest data to determine one or more points of interest that are visible from the map projection cell. Based on determining a point of interest (e.g., the 986 S Michigan Ave. building), the computing device can generate the indication 714 which indicates “986 S MICHIGAN AVE.” below the image of the building displayed in the interface 712. In this example, the point of interest is mostly occluded by the object 716 (e.g., a tree) and the indication 714 is generated in a location that does not further occlude the point of interest. As a result the point of interest and the indication 714 that is associated with the point of interest are visible in the interface 712.

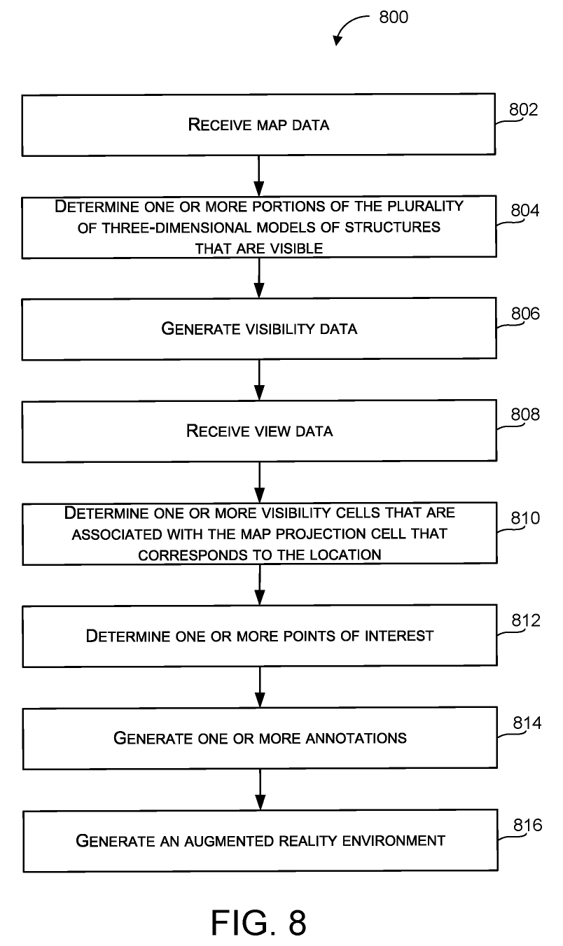

FIG. 8 depicts a flow chart diagram of an example method of determining the visibility of structures in an environment according to example embodiments of the present disclosure. One or more portions of the method 800 can be executed and/or implemented on one or more computing devices or computing systems comprising, for example, the computing device 102, the server computing system 130, the training computing system 150, and/or the computing device 300. Further, one or more portions of the method 800 can be executed or implemented as an algorithm on the hardware devices or systems disclosed herein. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include receiving map data that can comprise a plurality of three-dimensional models of structures in a physical environment. For example, the server computing system 130 can receive map data that is based on a plurality of three-dimensional models of structures in a physical environment. Further, the plurality of three-dimensional models of structures in a physical environment can be based on scans of structures comprising buildings in a city environment.

At 804, the method 800 can include determining one or more portions of the plurality of three-dimensional models of structures that may be visible from each map projection cell of a plurality of map projection cells that correspond to a plurality of locations in the physical environment. For example, the server computing system 130 can determine one or more portions of the plurality of three-dimensional models of structures that are visible from each map projection cell of a plurality of map projection cells that correspond to a plurality of locations in a physical environment comprising a city.

At 806, the method 800 can include generating visibility data that can comprise a plurality of visibility cells associated with the plurality of map projection cells. Each visibility cell of the plurality of visibility cells can be associated with the one or more portions of the plurality of three-dimensional models of structures that are visible from each map projection cell of the plurality of map projection cells. For example, the server computing system 130 can perform ray casting operations on the plurality of three-dimensional models of structures as part of generating the visibility data.

At 808, the method 800 can include receiving view data that can comprise information associated with a visual representation of the physical environment that is visible from a location of the plurality of locations in the physical environment. For example, the server computing system 130 can receive view data that comprises video based on the physical environment.

At 810, the method 800 can include determining, based on the view data and the visibility data, one or more visibility cells of the plurality of visibility cells that are associated with the map projection cell that corresponds to the location in the physical environment. For example, the server computing system 130 can access point of interest data that comprises points of interest and determine the points of interest that are associated with the one or more visibility cells that correspond to the location in the physical environment.

At 812, the method 800 can include determining, based on point of interest data, one or more points of interest associated with the visibility cell. For example, the server computing system 130 can determine the one or more points of interest that correspond to the visibility cell.

At 814, the method 800 can include generating one or more annotations based on the one or more points of interest that are visible from the map projection cell associated with the location. For example, the server computing system 130 can generate one or more annotations that can be added to view data. By way of further example, the server computing system 130 can generate modified view data that is based on the view data and the one or more annotations.

At 816, the method 800 can include generating an augmented reality environment based on the view data and the one or more annotations. For example, the server computing system 130 can implement an augmented reality application that can generate an augmented reality environment based on the view data and/or the one or more annotations.

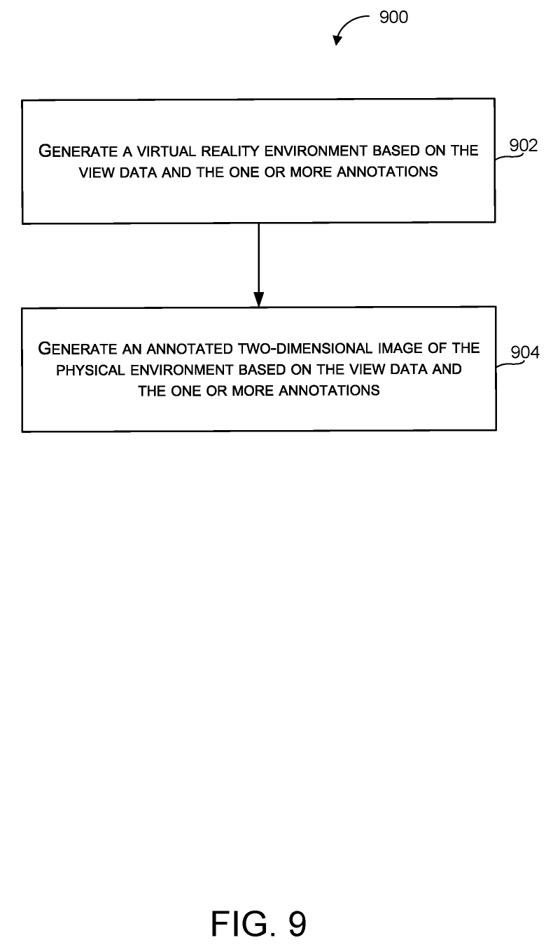

FIG. 9 depicts a flow chart diagram of an example method of determining the visibility of structures in an environment according to example embodiments of the present disclosure. One or more portions of the method 900 can be executed and/or implemented on one or more computing devices or computing systems comprising, for example, the computing device 102, the server computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 800 that is described with respect to FIG. 8. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include generating a virtual reality environment based on the view data comprising a three-dimensional representation of the physical environment and/or the one or more annotations. For example, the server computing system 130 can generate a virtual reality environment based on a three-dimensional representation of a city.

At 904, the method 900 can include generating an annotated two-dimensional image of the physical environment based on the view data comprising the two-dimensional image of the physical environment and/or the one or more annotations. For example, the server computing system 130 can generate annotated two-dimensional images of an archeological site based on view data of the archeological site and one or more annotations indicating points of interest in the archeological site.

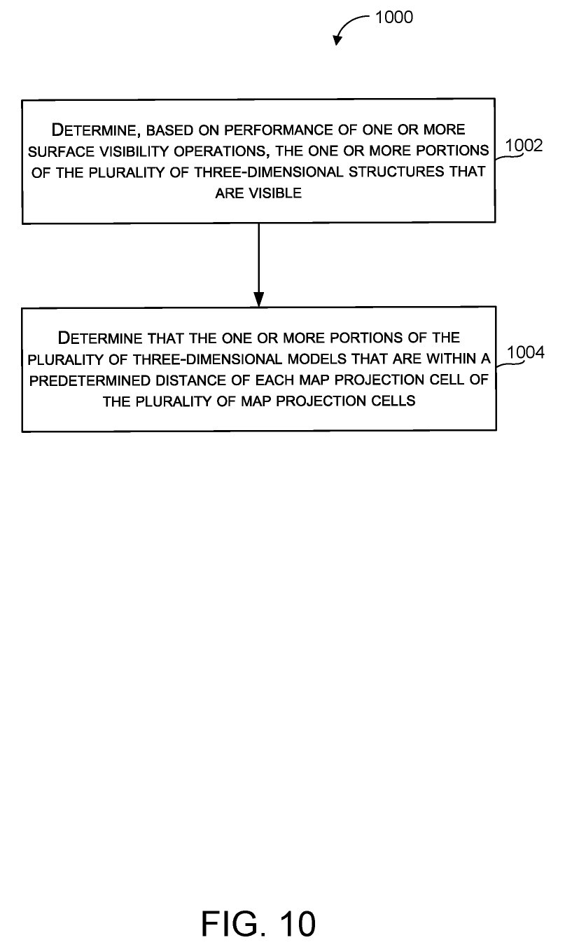

FIG. 10 depicts a flow chart diagram of an example method of determining the visibility of structures in an environment according to example embodiments of the present disclosure. One or more portions of the method 1000 can be executed and/or implemented on one or more computing devices or computing systems comprising, for example, the computing device 102, the server computing system 130, the training computing system 150, and/or the computing device 300. Further, one or more portions of the method 1000 can be executed or implemented as an algorithm on the hardware devices or systems disclosed herein. In some embodiments, one or more portions of the method 1000 can be performed as part of the method 800 that is described with respect to FIG. 8. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include determining, based on performance of one or more surface visibility operations, the one or more portions of the plurality of three-dimensional models of structures that are visible from each map projection cell of a plurality of map projection cells that correspond to the plurality of locations in the physical environment. The one or more surface visibility operations can comprise one or more ray casting operations and/or one or more ray tracing operations. For example, the server computing system 130 can perform one or more ray casting operations to determine the one or more portions of the plurality of three-dimensional models of structures that are visible from each map projection cell of a plurality of map projection cells that correspond to the plurality of locations in the physical environment.

At 1004, the method 1000 can include determining that the one or more portions of the plurality of three-dimensional models of structures are within a predetermined distance of each map projection cell of the plurality of map projection cells. For example, the server computing system 130 can determine that the one or more portions of the plurality of three-dimensional models of structures are no more than two kilometers from the map projection cell.

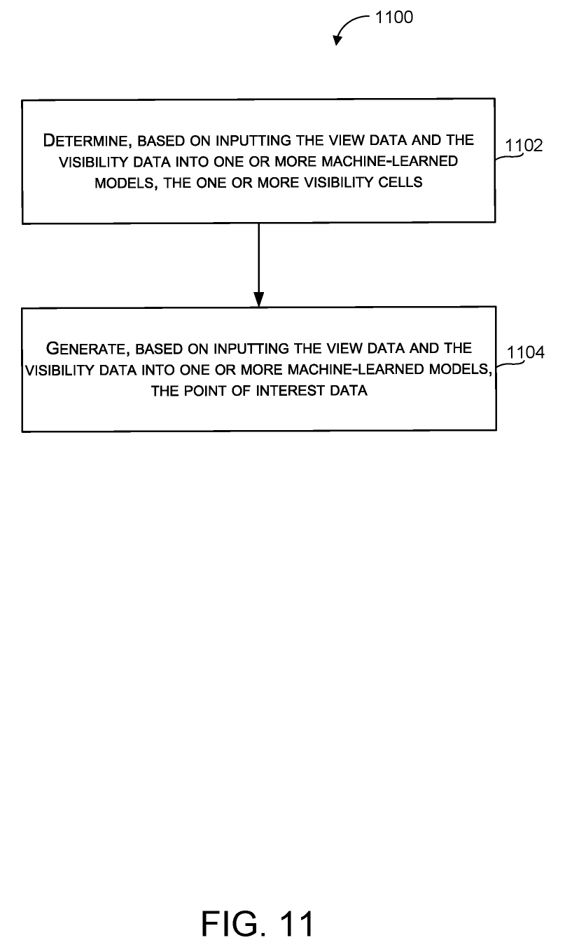

FIG. 11 depicts a flow chart diagram of an example method of determining the visibility of structures in an environment according to example embodiments of the present disclosure. One or more portions of the method 1100 can be executed and/or implemented on one or more computing devices or computing systems comprising, for example, the computing device 102, the server computing system 130, the training computing system 150, and/or the computing device 300. Further, one or more portions of the method 1100 can be executed or implemented as an algorithm on the hardware devices or systems disclosed herein. In some embodiments, one or more portions of the method 1100 can be performed as part of the method 800 that is described with respect to FIG. 8. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include determining, based on inputting the view data and the visibility data into one or more machine-learned models, the one or more visibility cells that are associated with the map projection cell that corresponds to the location in the physical environment. The one or more machine-learned models can be configured and/or trained to determine the one or more visibility cells that are associated with the map projection cell that corresponds to the location in the physical environment based on detection, recognition, or classification of one or more features of one or more two-dimensional images. For example, the server computing system 130 can implement one or more machine-learned models that can generate, based on input comprising a plurality of images of a physical environment (e.g., images of a city), output comprising the one or more visibility cells that are associated with the map projection cell that corresponds to the location in the physical environment.

At 1104, the method 1100 can include generating, based on inputting a plurality of images of the physical environment into one or more machine-learned models, the point of interest data. The one or more machine-learned models can be configured and/or trained to generate the point of interest data based on detection, recognition, and/or classification of one or more features of the plurality of images that correspond to one or more points of interest. For example, the server computing system 130 can implement one or more machine-learning models that can generate the point of interest data based on input comprising a plurality of images of a physical environment (e.g., images of a town).

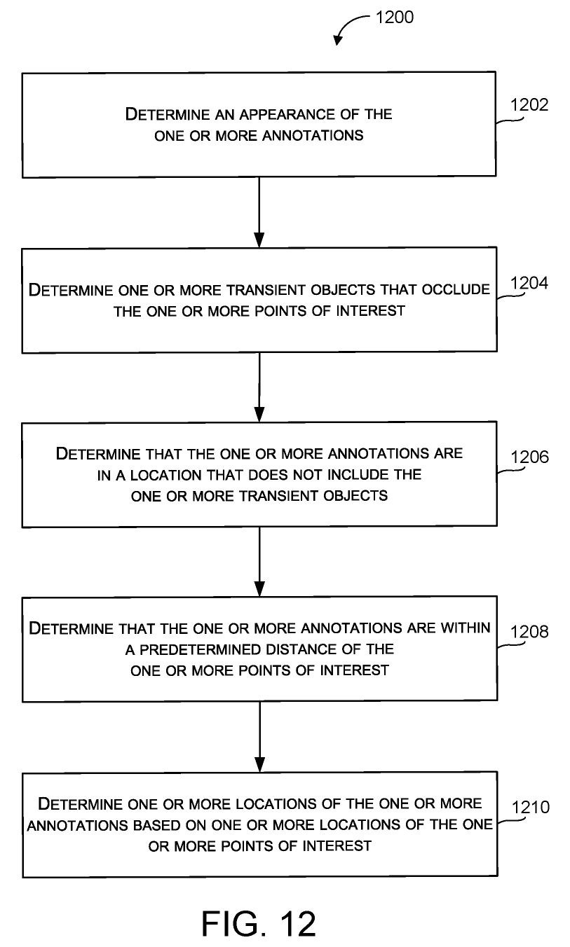

FIG. 12 depicts a flow chart diagram of an example method of determining the visibility of structures in an environment according to example embodiments of the present disclosure. One or more portions of the method 1200 can be executed and/or implemented on one or more computing devices or computing systems comprising, for example, the computing device 102, the server computing system 130, the training computing system 150, and/or the computing device 300. Further, one or more portions of the method 1200 can be executed or implemented as an algorithm on the hardware devices or systems disclosed herein. In some embodiments, one or more portions of the method 1200 can be performed as part of the method 800 that is described with respect to FIG. 8. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include determining an appearance of the one or more annotations based on a distance of the one or more points of interest from the map projection cell. The appearance of the one or more annotations can comprise the size of the one or more annotations and/or a color of the one or more annotations. For example, the server computing system 130 can determine that the one or more annotations can be a white color to provide improved legibility against a dark background such as the dark walls of a building that is a point of interest.

At 1204, the method 1200 can include determining one or more transient objects that occlude the one or more points of interest. The one or more transient objects can comprise one or more vehicles, foliage, one or more temporary signs, and/or one or more pedestrians. For example, the server computing system 130 can implement one or more machine-learned models that are configured to recognize one or more transient objects based on processing the map data and/or view data as input. Further, the one or more machine-learned models can determine that the one or more transient objects comprising a vehicle occlude a point of interest.

At 1206, the method 1200 can include determining that the one or more annotations are in a location that does not include the one or more transient objects. For example, based on the determination that a transient object (e.g., a delivery truck) is occluding a portion of a point of interest, the server computing system 130 can determine that the location in which the one or more annotations are generated does not occupy the same region as the transient object.

At 1208, the method 1200 can include determining, based on the visibility data, that the one or more annotations are within a predetermined distance of the one or more points of interest. For example, the server computing system 130 can determine that the one or more annotations appear to be close to the point of interest such that points of interest that are far away from a projected map cell (e.g., a point of interest that is one kilometer away from the projected map cell) can be associated with annotations that are smaller than points of interest that are closer to the projected map cell (e.g., a point of interest that is twenty meters away from the projected map cell).

At 1210, the method 1200 can include determining one or more locations of the one or more annotations based on one or more locations of the one or more points of interest. For example, the server computing system 130 can determine that the one or more annotations can be located above a point of interest, at a centroid of a point of interest, and/or that the one or more annotations can be placed a predetermined distance away from one or more other annotations.

Further to the descriptions above, a user may be provided with controls allowing the user to make an election as to both if and/or when systems, programs, or features described herein may enable collection of user information (e.g., image information), and if the user is sent data or communications from a server. In addition, certain data may be treated in one or more ways before it is stored or used, so that certain information of a user may be removed. For example, a user’s identity may be treated so that certain other information associated with the user’s identity may not be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of determining a visibility of structures in an environment, the computer-implemented method comprising:
receiving, by a computing system comprising one or more processors, map data comprising a plurality of three-dimensional models of structures in a physical environment;
determining, by the computing system, one or more portions of the plurality of three-dimensional models of structures that are visible from each map projection cell of a plurality of map projection cells that correspond to a plurality of locations in the physical environment;
generating, by the computing system, visibility data comprising a plurality of visibility cells associated with the plurality of map projection cells and the one or more portions of the plurality of three-dimensional models of structures that are visible from each map projection cell of the plurality of map projection cells;
receiving, by the computing system, view data comprising information associated with a visual representation of the physical environment from a location of the plurality of locations in the physical environment;
determining, by the computing system, based on the view data and the visibility data, one or more visibility cells of the plurality of visibility cells that are associated with the map projection cell that corresponds to the location in the physical environment;
determining, by the computing system, based on point of interest data, one or more points of interest associated with the one or more visibility cells; and
generating, by the computing system, one or more annotations based on the one or more points of interest that are visible from the map projection cell associated with the location.

2. The computer-implemented method of claim 1, wherein the view data comprises a video stream associated with the visual representation of the physical environment from a field of view of an image capture device at the location, and further comprising:
generating, by the computing system, an augmented reality environment based on the view data comprising the video stream and the one or more annotations.

3. The computer-implemented method of claim 1, wherein the view data comprises a three-dimensional representation of the physical environment, and wherein surfaces of the three-dimensional representation of the physical environment are based on images of corresponding surfaces of the physical environment, and further comprising:
generating, by the computing system, a virtual reality environment based on the view data comprising the three-dimensional representation of the physical environment and the one or more annotations.

4. The computer-implemented method of claim 1, wherein the view data comprises a two-dimensional image of the physical environment, and further comprising:
generating, by the computing system, an annotated two-dimensional image of the physical environment based on the view data comprising the two-dimensional image of the physical environment and the one or more annotations.

5. The computer-implemented method of claim 1, wherein the determining, by the computing system, one or more portions of the plurality of three-dimensional models of structures that are visible from each map projection cell of a plurality of map projection cells that correspond to a plurality of locations in the physical environment comprises:
determining, by the computing system, based on performance of one or more surface visibility operations, the one or more portions of the plurality of three-dimensional models of structures that are visible from each map projection cell of a plurality of map projection cells that correspond to the plurality of locations in the physical environment, wherein the one or more surface visibility operations comprise one or more ray casting operations or one or more ray tracing operations.

6. The computer-implemented method of claim 1, wherein the determining, by the computing system, one or more portions of the plurality of three-dimensional models of structures that are visible from each map projection cell of a plurality of map projection cells that correspond to a plurality of locations in the physical environment comprises:
determining, by the computing system, that the one or more portions of the plurality of three-dimensional models of structures are within a predetermined distance of each map projection cell of the plurality of map projection cells.

7. The computer-implemented method of claim 1, wherein the view data comprises one or more two-dimensional images of the physical environment, and wherein the determining, based on the view data and the visibility data, one or more visibility cells of the plurality of visibility cells that are associated with the map projection cell that corresponds to the location in the physical environment comprises:
determining, by the computing system, based on inputting the view data and the visibility data into one or more machine-learned models, the one or more visibility cells that are associated with the map projection cell that corresponds to the location in the physical environment, wherein the one or more machine-learned models are configured to determine the one or more visibility cells that are associated with the map projection cell that corresponds to the location in the physical environment based on detection, recognition, or classification of one or more features of the one or more two-dimensional images.

8. The computer-implemented method of claim 1, further comprising:
generating, by the computing system, based on inputting a plurality of images of the physical environment into one or more machine-learned models, the point of interest data, wherein the one or more machine-learned models are configured to generate the point of interest data based on detection, recognition, or classification of one or more features of the plurality of images that correspond to one or more points of interest.

9. The computer-implemented method of claim 1, wherein the view data is received from a mobile computing device comprising a camera, a smartphone, augmented reality glasses, or an extended reality headset.

10. The computer-implemented method of claim 1, wherein the generating, by the computing system, one or more annotations based on the one or more points of interest that are visible from the map projection cell associated with the location comprises:
determining, by the computing system, an appearance of the one or more annotations based on a distance of the one or more points of interest from the map projection cell, wherein the appearance of the one or more annotations comprises a size of the one or more annotations or a color of the one or more annotations.

11. The computer-implemented method of claim 1, wherein the generating, by the computing system, one or more annotations based on the one or more points of interest that are visible from the map projection cell associated with the location comprises:
determining, by the computing system, one or more transient objects that occlude the one or more points of interest, wherein the one or more transient objects comprise one or more vehicles, foliage, one or more temporary signs, or one or more pedestrians; and
determining, by the computing system, that the one or more annotations are in a location that does not include the one or more transient objects.

12. The computer-implemented method of claim 1, wherein the generating, by the computing system, one or more annotations based on the one or more points of interest that are visible from the map projection cell associated with the location comprises:
determining, by the computing system, based on the visibility data, that the one or more annotations are within a predetermined distance of the one or more points of interest.

13. The computer-implemented method of claim 1, wherein the generating, by the computing system, one or more annotations based on the one or more points of interest that are visible from the map projection cell associated with the location comprises:
determining, by the computing system, one or more locations of the one or more annotations based on one or more locations of the one or more points of interest.

14. The computer-implemented method of claim 13, wherein the plurality of three-dimensional models of structures are associated with one or more bounding boxes, and wherein the one or more annotations are located at one or more centroids of the one or more bounding boxes associated with the one or more points of interest.

15. The computer-implemented method of claim 1, wherein the structures comprise one or more buildings, one or more statues, one or more fountains, one or more gates, one or more roads, one or more trees, one or more vehicles, one or more natural formations, or one or more bridges.

16. The computer-implemented method of claim 1, wherein the plurality of map projection cells comprise a plurality of S2 cells.

17. One or more tangible non-transitory computer-readable media storing computer-readable instructions that when executed by one or more processors cause the one or more processors to perform operations, the operations comprising:
receiving map data comprising a plurality of three-dimensional models of structures in a physical environment;
determining one or more portions of the plurality of three-dimensional models of structures that are visible from each map projection cell of a plurality of map projection cells that correspond to a plurality of locations in the physical environment;
generating visibility data comprising a plurality of visibility cells associated with the plurality of map projection cells and the one or more portions of the plurality of three-dimensional models of structures that are visible from each map projection cell of the plurality of map projection cells;
receiving view data comprising information associated with a visual representation of the physical environment from a location of the plurality of locations in the physical environment;
determining, based on the view data and the visibility data, one or more visibility cells of the plurality of visibility cells that are associated with the map projection cell that corresponds to the location in the physical environment;
determining, based on point of interest data, one or more points of interest associated with the one or more visibility cells; and
generating one or more annotations based on the one or more points of interest that are visible from the map projection cell associated with the location.

18. The one or more tangible non-transitory computer-readable media of claim 17, wherein the view data comprises a video stream associated with the visual representation of the physical environment from a field of view of an image capture device at the location.

19. A computing system comprising:
one or more processors;
one or more non-transitory computer-readable media storing instructions that when executed by the one or more processors cause the one or more processors to perform operations comprising:
receiving map data comprising a plurality of three-dimensional models of structures in a physical environment;
determining one or more portions of the plurality of three-dimensional models of structures that are visible from each map projection cell of a plurality of map projection cells that correspond to a plurality of locations in the physical environment;
generating visibility data comprising a plurality of visibility cells associated with the plurality of map projection cells and the one or more portions of the plurality of three-dimensional models of structures that are visible from each map projection cell of the plurality of map projection cells;
receiving view data comprising information associated with a visual representation of the physical environment from a location of the plurality of locations in the physical environment;
determining, based on the view data and the visibility data, one or more visibility cells of the plurality of visibility cells that are associated with the map projection cell that corresponds to the location in the physical environment;
determining, based on point of interest data, one or more points of interest associated with the one or more visibility cells; and
generating one or more annotations based on the one or more points of interest that are visible from the map projection cell associated with the location.

20. The computing system of claim 19, wherein the view data comprises a video stream associated with the visual representation of the physical environment from a field of view of an image capture device at the location.
